(19) United States
(12) Patent Application Publication
(10) Pub. No.: US 2011/0027100 A1
(43) Pub. Date: Feb. 3, 2011

(54) MOBILE WIND POWER STATION

(76) Inventors: Daniel Francis Cummane, Homer Glen, IL (US); Victoria Sherry Wright, Raleigh, NC (US)

Correspondence Address: BARNES & THORNBURG LLP, 11 SOUTH MERIDIAN, INDIANAPOLIS, IN, 46204, US

(21) Appl. No.: 12/512,688

(22) Filed: Jul. 30, 2009

(51) Int. Cl. F03D 11/04; B23P 11/00

(52) U.S. Cl. 416/244 R; 29/889

(57) ABSTRACT

A mobile wind power station includes a wind turbine secured to a tower. A base of the tower is coupled to a support, which includes a mobile, surface-mounted pedestal and a plurality of bolts. The plurality of bolts extend upwardly from the mobile, surface-mounted pedestal and are received in the base of the tower.

### TECHNICAL FIELD

The present disclosure relates generally to wind power stations, and more particularly to a support for a mobile wind power station.

### BACKGROUND

A wind power station generates electrical power from naturally occurring airflow patterns. Wind power stations are used in off-shore “wind farms” to take advantage of the winds flowing over bodies of water. Wind power stations are also used in land-based wind farms. Multiple wind power stations are sometimes used at a single wind farm to increase the amount of power generated.

A wind power station typically includes a support that is designed to withstand the stresses produced by the wind power station.

### SUMMARY

According to one aspect, a support for a mobile wind power station has a mobile, surface-mounted pedestal including an upper surface opposite a ground-contacting surface and a plurality of lift hooks secured to the pedestal. The plurality of lift hooks are configured to support the weight of the pedestal during the transport and positioning thereof. A plurality of bolts extend upwardly from the upper surface of the pedestal, and each of the bolts is configured to be received in a corresponding opening formed in a base of a wind turbine tower.

In some embodiments, the pedestal may include a sidewall extending from the ground-contacting surface to the upper surface, and a passageway extending between the upper surface and the sidewall of the pedestal. The passageway is sized to receive electrical and grounding cables extending from the tower when the tower and its corresponding turbine are positioned on the pedestal. Additionally, in some embodiments, the support may include a bubble indicator secured to the pedestal.

In some embodiments, the pedestal may include a mounting surface positioned above the upper surface of the pedestal. The mounting surface is configured to receive the base of the tower, and the plurality of bolts extend upwardly from the mounting surface.

In some embodiments, the support may include a metal shell sized to enclose the plurality of bolts and the base of the tower when the plurality of bolts are received in the holes formed in the base. A gasket may line an interior surface of the shell. The gasket is configured to engage with the tower and the pedestal.

Additionally, in some embodiments, the pedestal may be formed from precast concrete. In some embodiments, the pedestal may be formed from a plurality of components.

In some embodiments, the pedestal may include a lower body component having an upper mating surface opposite the ground-contacting surface and an upper body component separate from the lower body component. The upper body component includes a lower mating surface opposite the upper surface. The upper mating surface of the lower body component contacts the lower mating surface of the upper body component.

In some embodiments, the plurality of lift hooks may include a first lift hook secured to the lower body component and a second lift hook secured to the upper body component. The first lift hook is configured to support the weight of the lower body component during the transport and positioning thereof. The second lift hook is configured to support the weight of the upper body component during the transport and positioning thereof.

Additionally, in some embodiments, the lower body component may include a column extending upwardly from the upper mating surface. The column has a mounting surface formed at a distal end thereof, and the mounting surface is configured to receive the base of the tower. The upper body component includes an opening extending from the lower mating surface to the upper surface, and the opening is sized to receive the column. In some embodiments, the mounting surface of the column may be positioned above the upper surface.

In some embodiments, the lower body component may include a sidewall extending from the ground-contacting surface to the upper mating surface, and a passageway may extend from an opening formed in the mounting surface of the column to an opening formed in the sidewall. The passageway is sized to receive electrical and grounding cables extending from the tower when the tower and its corresponding turbine are positioned on the pedestal.

In some embodiments, the support may include a plurality of connecting plates. Each of the connecting plates is secured to the upper body component and the lower body component.

According to another aspect, a method of deploying a mobile wind power station includes the steps of positioning a pedestal formed from precast concrete on the ground, and installing a tower and a wind turbine on the pedestal. In some embodiments, the method may include the step of leveling the ground with crushed rock prior to performing the positioning step. Additionally, in some embodiments, the positioning step may include using a plurality of lift hooks configured to support the weight of the pedestal to position the pedestal on the ground.

In some embodiments, the positioning step further may include positioning a first body component, positioning a second body component, and coupling the first body component to the second body component to form the pedestal. In some embodiments, the method may include placing approximately two feet below the ground surface at least one electrical grounding device that extends horizontally. The method may also include passing a grounding cable through a passageway extending from an upper surface of the pedestal to a sidewall of the pedestal and connecting the wind turbine to the at least one electrical grounding device.

According to another aspect, a mobile wind power station includes a wind turbine having a nacelle and a set of rotor blades. The set of rotor blades are operable to rotate on a shaft extending from the nacelle. A tower extends from a base to an upper end, and the upper end of the tower is coupled to the nacelle. A support is coupled to the base of the tower. The support includes a mobile, surface-mounted pedestal, and the pedestal has a plurality of lift hooks configured to support the weight of the pedestal during the transport and positioning thereof. An electrical grounding device is coupled to the wind turbine.

In some embodiments, the pedestal may be formed from at least two separate body components, and each body component is formed from precast concrete.

According to another aspect, a support for a mobile wind power station includes a mobile, surface-mounted pedestal having an upper surface opposite a ground-contacting surface, and a plurality of bolts extending upwardly from the upper surface of the pedestal. Each of the bolts is configured to be received in a corresponding opening formed in a base of a wind turbine tower. In some embodiments, the pedestal may be formed from precast concrete.

### BRIEF DESCRIPTION OF THE DRAWINGS

The detailed description particularly refers to the following figures, in which:

FIG. 1 is a perspective view of an embodiment of a mobile wind power station;

FIG. 2 is a perspective view of one embodiment of a mobile, surface-mounted pedestal of the mobile wind power station of FIG. 1;

FIG. 3 is a cross-sectional view of the pedestal of FIG. 2 taken along the line 3-3 as shown in FIG. 2;

FIG. 4 is a cross-sectional view of the pedestal of FIG. 2 taken along the line 4-4 as shown in FIG. 2 and illustrating portions of the pedestal in cutaway;

FIG. 5 is a view similar to FIG. 2, but showing a modular version of the mobile, surface-mounted pedestal;

FIG. 6 is an exploded view of the modular pedestal of FIG. 5; and

FIG. 7 is a simplified flow diagram of a method of deploying the mobile wind power station of FIG. 1 at a wind farm.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

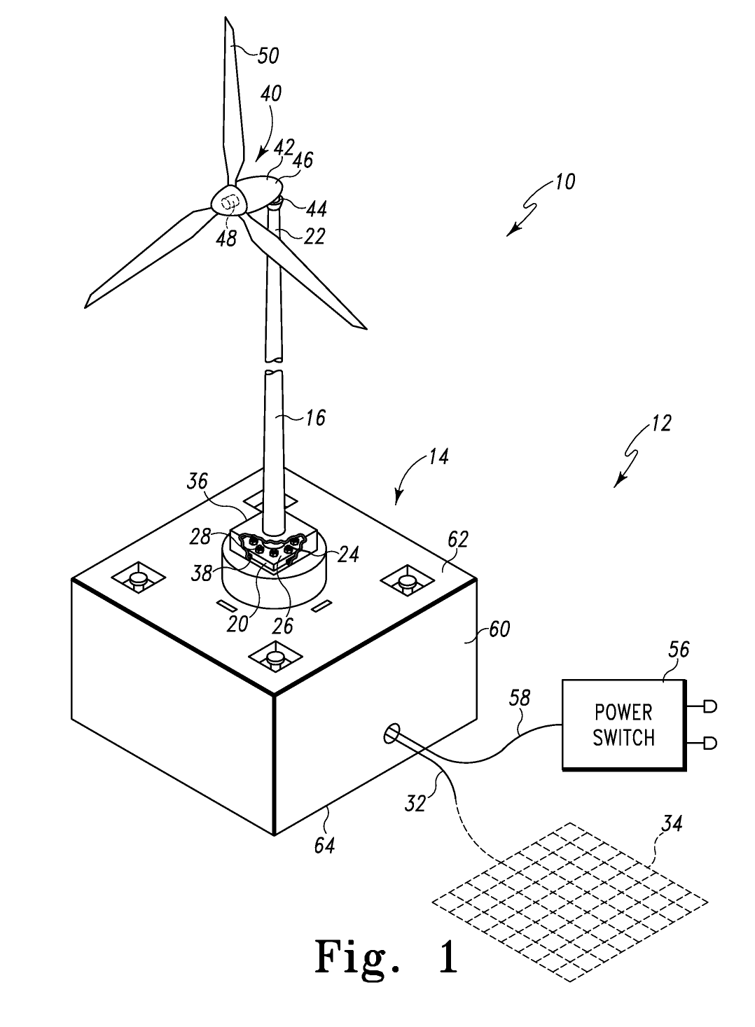

Referring to FIG. 1, a mobile wind power station 10 is shown positioned at a wind farm 12. The mobile wind power station 10 includes a mobile, surface-mounted pedestal 14 having a wind turbine secured thereto atop a tower. What is meant herein by the term “surface-mounted,” as used in regard to the pedestal, is a structure that is configured to be set atop the ground (or a prepared surface of the ground) and, as a result, supports the weight of, and handles the stresses generated by, the wind turbine and the tower substantially by gravity alone and without the assistance of support along its vertically-arranged sides. As such, a “surface-mounted” structure is distinguishable from, and, in contrast to, a conventional foundation or support, which is positioned substantially below the surface of the ground or underwater thereby relying on the surrounding ground or water to provide additional structural support along its vertically-arranged sides. At the same time, the term “surface-mounted” does not exclude structures positioned only partially below the topsoil layer of the ground. For example, at some sites, the surface vegetation and topsoil layers may be removed and replaced with a layer of rocks or crushed stone. In those locations, while a surface-mounted pedestal may contact the layer of rocks or crushed stone below the topsoil layer, the surrounding layer of ground does not provide any structural support to the vertically-arranged sides of the surface-mounted pedestal.

What is meant herein by the term “mobile,” as used in regard to the pedestal, is a structure that is moveable from site to site without significant modification thereto and is, hence, not fixed at one location. As such, a mobile pedestal is distinguishable from, and, in contrast to, a conventional foundation or support, which is generally constructed as a permanent structure at the installation site and positioned substantially below the surface of the ground as a permanent footing or support for the tower of the wind turbine much in the same way a permanent foundation is erected for a building.

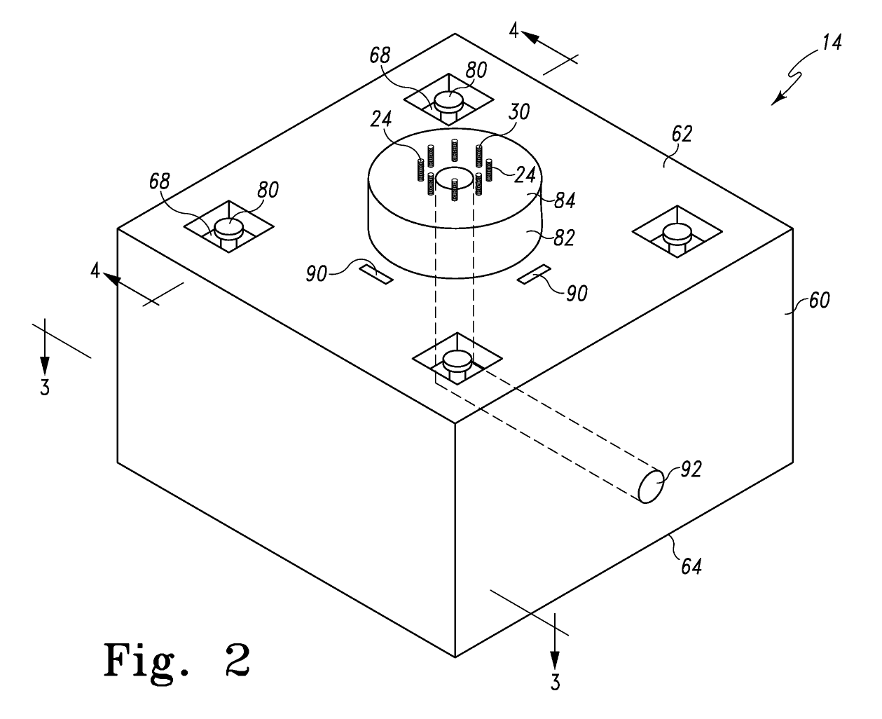

Returning to FIG. 1, the mobile, surface-mounted pedestal 14 is coupled to a base 20 of a wind turbine tower 16. As shown in FIG. 2, the mobile, surface-mounted pedestal 14 includes a plurality of bolts 24, each of which is received in a corresponding opening (not shown) formed in a flange 26 of the base 20. A nut 28 is coupled to a threaded end 30 of each bolt 24 to secure the flange 26 of the base 20 to the mobile, surface-mounted pedestal 14.

Additionally, a grounding cable 32 couples the flange 26 to a buried grounding device 34 in order to electrically ground the mobile wind power station 10. The grounding device may take several different forms. As shown in FIG. 1, the grounding device 34 is embodied as a metallic screen of solid copper rods arranged in the form of a grid. It will be appreciated that in other embodiments the grounding device may be a metallic rod that has been inserted vertically into the ground. However, it will be appreciated that because the metallic screen extends horizontally at a depth of approximately two feet below the ground surface, the metallic screen offers some unique advantages. For example, the metallic screen allows the mobile wind power station 10 to be deployed in landfills, areas having a high-water table, and other land areas requiring a shallow burial depth.

A removable metal shell 36 encloses the bolts 24 and the flange 26 of the base 20 of the tower 16. A gasket 38 lines an interior surface (not shown) of the shell 36 and engages with the tower 16 and the mobile, surface-mounted pedestal 14. The shell 36 and the gasket 38 prevent tampering with the bolts 24 and the flange 26 and provide protection against weather-related damage.

A wind turbine 40 is secured to an upper end 22 of the tower 16. In the embodiment of FIG. 1, the wind turbine 40 is a Skystream 3.7 turbine, which is commercially available from Southwest Windpower of Flagstaff, Ariz. The wind turbine 40 includes a nacelle 42 having a mounting plate 44 formed at a tail end 46. The upper end 22 of the tower 16 includes a bearing (not shown), which is coupled to the mounting plate 44 such that the wind turbine 40 is free to rotate about the tower 16. A set of rotor blades 50 are mounted on a rotating shaft 48 extending from the nacelle 42.

As wind flows over the blades 50, the blades 50 and shaft 48 rotate. The shaft 48 is coupled to a gearbox (not shown) and generator (not shown) housed within the nacelle 42. As the shaft 48 rotates, it interacts with the gearbox and the generator to create electrical current, which is transferred to a power switch 56 via an electrical cable 58. The power switch 56 may be configured to provide the electrical current to, for example, a home, a construction site, a battery pack for storage, or a municipal power grid.

In addition to generating electrical current, the rotation of the blades 50 exerts a thrust load on the tower 16 that subjects the tower 16 to lateral stress. The magnitude of that stress is variable and dependent on, for example, the speed of the wind and the angular velocity of the blades 50 as the blades rotate. As shown in FIG. 1, the tower 16 is embodied as a monopole. In other embodiments, the tower 16 may be a lattice tower, a tower held upright by guylines, or any other tower design capable of supporting both the weight of the wind turbine 40 and withstanding the lateral stress produced by the rotating blades 50. In the embodiment of FIG. 1, the tower 16 is formed from tapered tubular steel. It will be appreciated that the tower 16 may also be formed from other metallic or composite materials of sufficient strength.

The thrust load generated by the rotating blades 50 causes the mobile, surface-mounted pedestal 14 to experience a bending moment of force. The magnitude of that bending moment is variable and dependent on the thrust load exerted by the blades 50 and the length of the tower 16. It will be appreciated that the mobile, surface-mounted pedestal 14 must be sized to withstand the maximum thrust load exerted by the specific combination of blades 50 and the tower 16 planned for a particular wind farm 12.

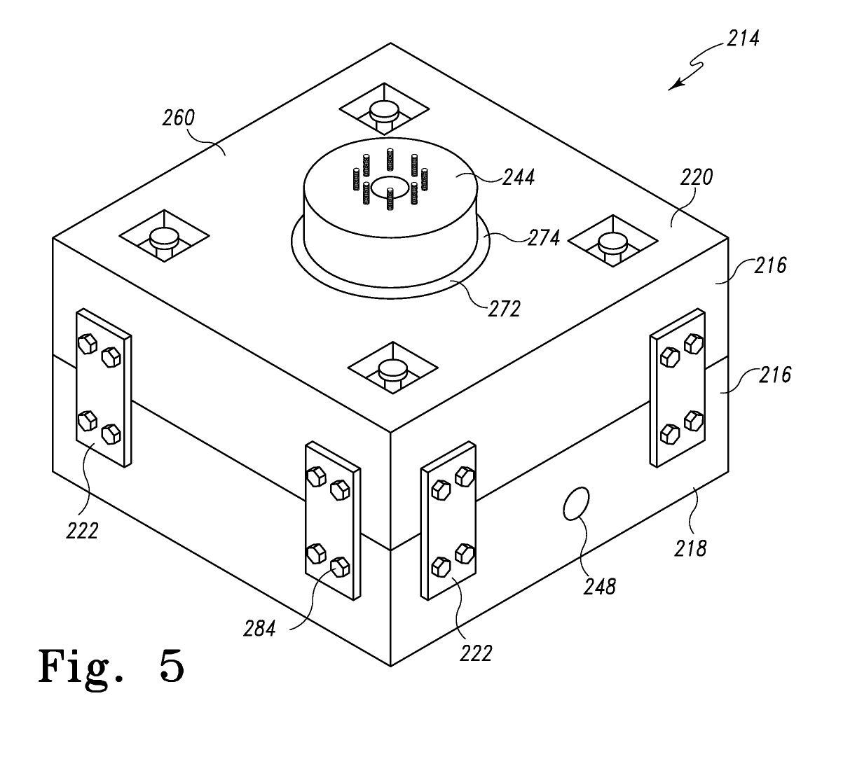

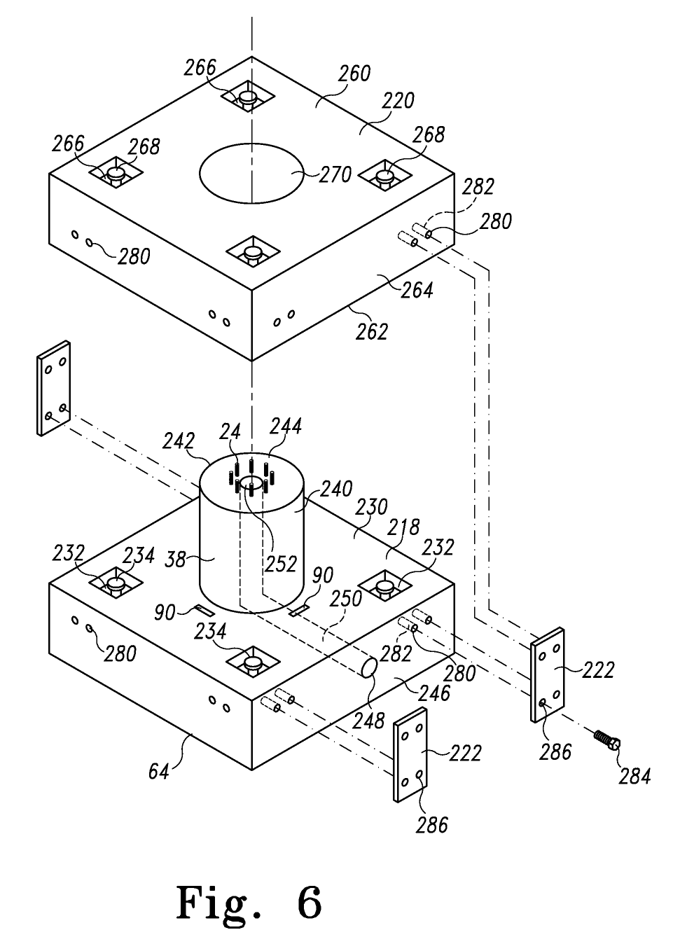

As shown in FIGS. 1 and 2, the mobile, surface mounted pedestal 14 is formed from precast concrete in a generally cube shape. The term “precast concrete” as used herein refers to concrete cast in a mould or other form and cured prior to transport to the wind farm 12. The mobile, surface-mounted pedestal also may be prefabricated from or include any other suitable material such as steel, iron, or composite materials. It will be appreciated that in other embodiments the mobile, surface-mounted pedestal 14 may take the form of a cylinder, prism, or any other suitable three-dimensional shape. In addition, a mobile, surface-mounted pedestal may be a unitary structure or a structure assembled from more than one component. The embodiment shown in FIGS. 1-4 is an example of the former while the embodiment shown in FIGS. 5 and 6 is an example of the latter.

The pedestal 14 of FIGS. 1 and 2 has a plurality of vertically-arranged sidewalls 60 extending between an upper surface 62 and a ground-contacting surface 64. The upper surface 62 has a plurality of apertures 68 formed therein. A lift hook 80 is secured to the mobile, surface-mounted pedestal 14 within each of the plurality of apertures 68.

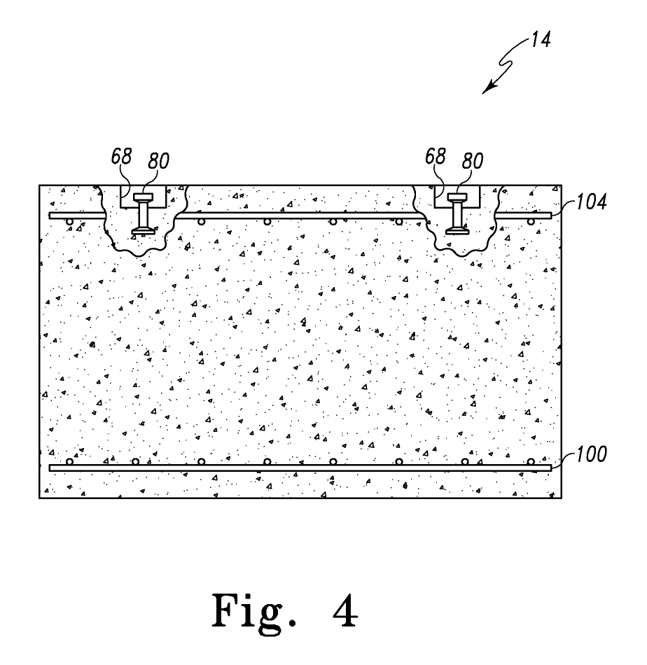

The term “lift hook” as used herein refers to any device configured to be engaged by the heavy equipment used to move the pedestal. A “lift hook” thereby supports the weight of the pedestal during transport and positioning of the pedestal at the wind farm. As such, a “lift hook” is distinguishable from flanges or other protrusions that may be associated with a pedestal but are not configured to support the weight of pedestal during movement thereof by heavy equipment. Each lift hook 80 extends downwardly into the interior portion of the pedestal 14 (see FIG. 4) and is secured to a tension bar (not shown) to provide additional strength and reinforcement to the lift hook 80. To move the pedestal 14, a crane or other type of heavy equipment is coupled to each of the lift hooks 80, which are used together to lift and position the pedestal 14. As shown in FIGS. 1 and 2, each of the lift hooks 80 is a P-52 Swift Lift Anchor, which is commercially available from Dayton Superior, Inc. of Dayton, Ohio. It should be appreciated that each of the lift hooks 80 may be embodied as any commercially available device capable of supporting the weight of the mobile, surface-mounted pedestal 14.

The pedestal 14 has a platform 82 that includes a mounting surface 84. As shown in FIG. 2, mounting surface 84 is positioned above the upper surface 62 of the pedestal 14; it should be appreciated that in other embodiments the mounting surface 84 may be flush or parallel with the upper surface 62. The plurality of bolts 24 extend upwardly from the mounting surface 84, which is sized to receive the flange 26 of the base 20 of the tower 16. Each of the bolts 24 also extends downwardly from the mounting surface 84 into the mobile, surface-mounted pedestal 14. Each of the bolts 24 is a stainless steel bolt having a threaded end 30 that receives the nut 28 to secure the flange 26 of the base 20 to the pedestal 14. It should be appreciated that the bolt 24 may also be formed from iron, composite steel, or any other material of sufficient strength.

A plurality of bubble indicators 90 are secured to the upper surface 62. Each bubble indicator 90 provides an indication of the orientation of the mobile, surface-mounted pedestal 14 relative to a flat, level reference surface. During the positioning of the pedestal 14, the bubble indicators 90 may be used to ensure that the pedestal 14 is level prior to installing the tower 16 thereon.

A passageway 92 extends between the mounting surface 84 and one of the sidewalls 60. In other embodiments, the passageway 92 may extend between the upper surface 62 and one of the sidewalls 60. The passageway 92 is formed from a hollow plastic pipe extending through the pedestal 14 and is sized to receive the grounding cable 32 that couples the flange 26 to the grounding device 34. The passageway 92 is also sized to receive the electrical cable 58 that couples the generator housed within the nacelle 42 to the power switch 56.

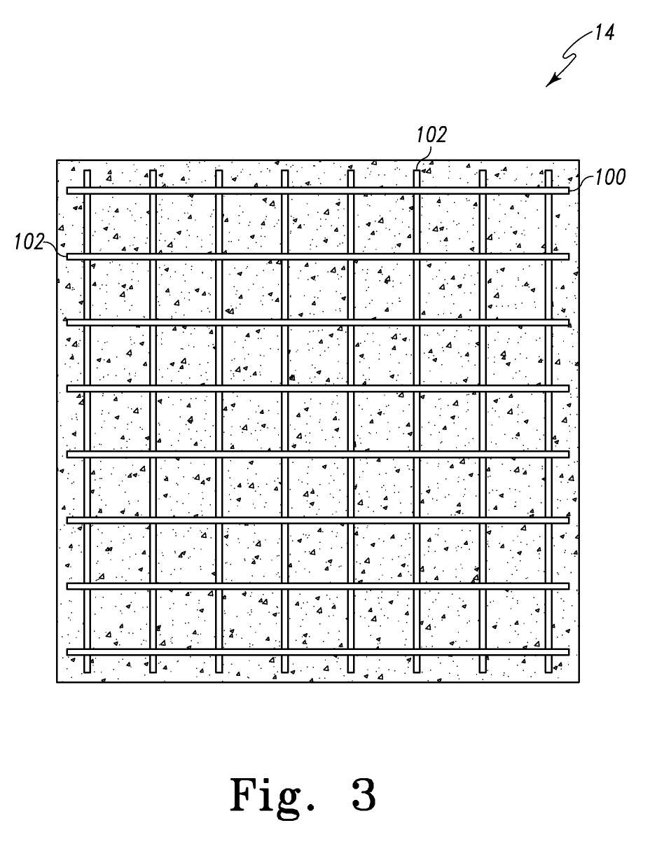

Referring to FIG. 3, a reinforcing structure 100 is disposed between the upper surface 62 and the ground-contacting surface 64. In the illustrative embodiment, the reinforcing structure 100 includes a plurality of rods 102 arranged in a square pattern. Each of the rods 102 is embodied as No. 6 Reinforcing Bar, which is also known as “REBAR.” It will be appreciated that in other embodiments the rods may be formed from REBAR of different sizes and strengths.

Referring to FIG. 4, an additional reinforcing structure 104 is positioned above the reinforcing structure 100 and below the upper surface 62. It will be appreciated that in other embodiments the mobile, surface-mounted pedestal 14 may include additional reinforcement structures depending on the expected size of the tower 16 and the maximum thrust load produced by the wind turbine 40. The portions of the pedestal 14 illustrated in cutaway show the lift hooks 80 extending downwardly into the interior of the pedestal 14.

Referring now to FIGS. 5 and 6, a different embodiment of a mobile, surface-mounted pedestal (hereinafter referenced as a modular pedestal 214) is illustrated. Some features of the embodiment illustrated in FIGS. 5 and 6 are substantially similar to those discussed above in reference to the embodiment of FIGS. 1-4. Such features are designated in FIGS. 5 and 6 with the same reference numbers as those used in FIGS. 1-4.

In the embodiment of FIGS. 5 and 6, the modular pedestal 214 includes a lower body component 218 coupled to an upper body component 220 via a plurality of connecting plates 222. It should be appreciated that in other embodiments additional body components may be used. In addition, rather than having an upper body component 220 and a lower body component 218, which are placed one atop the other, the modular pedestal 214 may include body components positioned side-by-side one another.

As shown FIG. 6, the lower body component 218 includes a ground-contacting surface 64 positioned opposite an upper mating surface 230. The upper mating surface 230 has a plurality of apertures 232 formed therein. A lift hook 234 is secured to the lower body component 218 within each of the plurality of apertures 232. As shown in FIGS. 5 and 6, each lift hook 234 is a P-52 Swift Lift Anchor. Like the lift hooks shown in the embodiment of FIGS. 1-4, each lift hook 234 is used to support the weight of the lower body component 218 during transport and positioning of the modular pedestal 214 by a crane or other type of heavy equipment. The upper mating surface 230 also has a plurality of bubble indicators 90 secured thereto. Like the bubble indicators of the embodiment of FIGS. 1-4, each bubble indicator 90 provides an indication of orientation of the mobile, surface-mounted pedestal 14 relative to a flat, level reference surface.

A cylindrical column 240 extends upwardly from the upper mating surface 230 to an upper end 242. The upper end 242 has a mounting surface 244 sized to receive a flange 26 of a base 20 of a tower 16. The mounting surface 244 has a plurality of bolts 24 extending upwardly therefrom. Each of the bolts 24 is received in a corresponding opening in the flange 26 of the tower 16.

A plurality of vertically-arranged sidewalls 246 extend from the ground-contacting surface 64 to the upper mating surface 230 of the lower body component 218. One of the sidewalls 246 has an opening 248 formed near the ground-contacting surface 64. A passageway 250 extends from an opening 252 formed in the mounting surface 244 to the opening 248 formed in the one of the sidewalls 246. The passageway 250 is sized to receive a grounding cable 32 that couples the flange 26 of the base 20 to a grounding device 34. The passageway 250 is also sized to receive an electrical cable 58 that couples the generator housed within a nacelle 42 of a wind turbine 40 to a power switch 56.

As shown in FIG. 6, the upper body component 220 includes an upper surface 260 positioned opposite lower mating surface 262. A plurality of vertically-arranged sidewalls 264 extend between the lower mating surface 262 and the upper surface 260. The upper surface 260 has a plurality of apertures 266 formed therein. A lift hook 268 is secured to the upper body component 220 within each of the plurality of apertures 266. As shown in FIGS. 5 and 6, each of the lift hooks 268 is a P-52 Swift Lift Anchor. While no bubble indicators are secured to the upper surface 260, it should be appreciated that such indicators could be secured thereto in other embodiments.

An opening 270 extends from the lower mating surface 262 to the upper surface 260 of the upper body component 220. As shown in FIG. 5, the opening 270 receives the column 240 of the lower body component 218. The mounting surface 244 of the column 240 is positioned above the upper surface 260 of the upper body component 220. A backer rod (not shown) covered by a non-shrink structural grout 272 seals a gap 274 formed between the column 240 and the opening 270.

Each of the sidewalls 246, 264 of the lower body component 218 and the upper body component 220, respectively, has a plurality of apertures 280 formed therein. Each of the apertures 280 is configured to secure the connecting plates 222 to the sidewalls 246, 264. In the embodiment of FIGS. 5 and 6, a threaded anchor 282 is secured within each of the apertures 280, and each threaded anchor 282 receives a bolt 284. To secure one of the connecting plates 222 to the sidewalls 246, 264, one bolt 284 is passed through each of the holes 286 extending through each of the connecting plates 222 and is received in the corresponding threaded anchor 282. After securing each of the connecting plates 222 to the sidewalls 246, 264, the upper mating surface 230 of the lower body component 218 contacts the lower mating surface 262 of the upper body component 220.

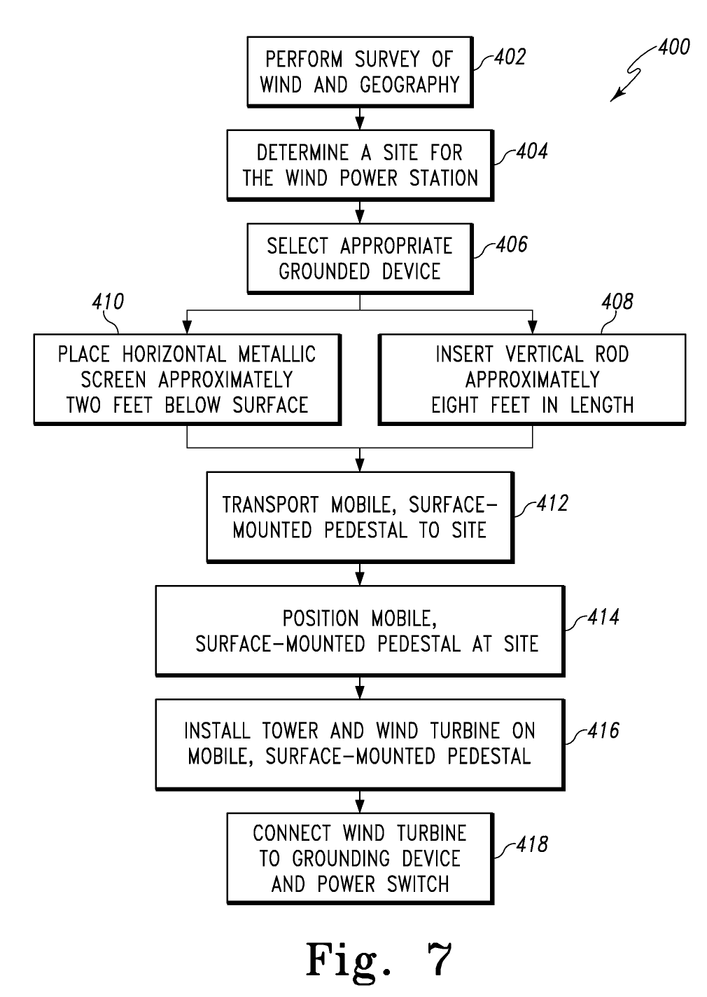

Referring to FIG. 7, a method 400 of installing the mobile wind power station 10 is illustrated. The method 400 includes process step 402 in which a survey of wind speed and geography is performed at a proposed wind farm 12. By virtue of its mobility, the station 10 need not be positioned at a permanent location. For example, the station 10 may be located in inner-city blight areas, landfills, construction sites, or other areas that require additional power on a short or long-term basis. Similarly, the station 10 may be used to provide power to victims of hurricanes, tornadoes, or any other natural disaster that disrupts the power grid. Thus, the wind farm 12 may be located in variety of different locations. After considering the wind speeds at various locations as well as the surrounding geography, a site for the mobile wind power station can be determined at process step 404.

At process step 406, an appropriate electrical grounding device 34 is selected. As discussed above, it will be possible at some wind farms 12 to use a conventional metallic rod as the grounding device 34, and, at process step 408, a rod is inserted into the ground vertically such that it extends to a depth of approximately eight feet. At other sites, soil conditions may require a shallow burial, and a metallic screen may be used as the grounding device instead. At process step 410, the metallic screen is buried horizontally, approximately two feet below the surface of ground.

At process step 412, a mobile, surface-mounted pedestal is transported to the wind farm 12. As discussed above, the pedestal includes devices such as lift hooks 80 that may be used to lift the pedestal onto a truck, train, or other form of transportation. Once loaded, the pedestal can be moved to the wind farm 12.

Upon arrival at the wind farm 12, the lift hooks of the pedestal are engaged by a crane or other type of heavy equipment in process step 414 to position the pedestal. If it is determined that the pedestal is not level, additional dirt or crushed rock may be added or removed under the ground-contacting surface of the pedestal to raise or lower it as necessary. When the mobile, surface-mounted pedestal is embodied as a modular pedestal, process step 414 also includes positioning each of the body components. Those body components are then coupled together to assemble the modular pedestal, and the assembled pedestal may then be leveled.

At some wind farms 12, it may be necessary to remove a layer of topsoil and add a layer of crushed rock or gravel to assist in leveling the pedestal prior to performing process step 414. After adding the crushed rock, the pedestal may be placed on the crushed rock and leveled as described above.

At process step 416, the tower 16 and wind turbine 40 are installed on the mobile, surface-mounted pedestal. The base 20 is lowered onto the plurality of bolts 24 extending upwardly from the pedestal. As described above, a nut 28 is threaded onto each of the bolts 24 to secure the flange 26 of the base 20 to the pedestal. The metal shell 36 is installed on the pedestal such that the flange 26 and bolts 24 are sealed within the shell 36.

During process step 416, the grounding cable 32 is secured to one of the bolts 24 and passed through a passageway formed in the pedestal. The electrical cable 58, which extends downwardly through tower 16 from the wind turbine 40, passes through the same passageway. At process step 418, the electrical cable 58 is connected to the external power switch 56. In addition, the grounding cable 32 is connected to the grounding device 34.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A support for a mobile wind power station, comprising:
a mobile, surface-mounted pedestal including an upper surface opposite a ground-contacting surface,
a plurality of lift hooks secured to the pedestal, the plurality of lift hooks being configured to support the weight of the pedestal during the transport and positioning thereof, and
a plurality of bolts extending upwardly from the upper surface of the pedestal, each of the bolts being configured to be received in a corresponding opening formed in a base of a wind turbine tower.

2. The support of claim 1, wherein the pedestal includes:
a sidewall extending from the ground-contacting surface to the upper surface, and
a passageway extending between the upper surface and the sidewall of the pedestal, the passageway being sized to receive electrical and grounding cables extending from the tower when the tower and its corresponding turbine are positioned on the pedestal.

3. The support of claim 1, further comprising a bubble indicator secured to the pedestal.

4. The support of claim 1, the pedestal further including a mounting surface positioned above the upper surface of the pedestal, the mounting surface being configured to receive the base of the tower,
wherein the plurality of bolts extend upwardly from the mounting surface.

5. The support of claim 4, further comprising:
a metal shell sized to enclose the plurality of bolts and the base of the tower when the plurality of bolts are received in the holes formed in the base, and
a gasket lining an interior surface of the shell, the gasket being configured to engage with the tower and the pedestal.

6. The support of claim 1, wherein the pedestal is formed from precast concrete.

7. The support of claim 1, wherein the pedestal is formed from a plurality of components.

8. The support of claim 1, wherein the pedestal includes:
a lower body component including an upper mating surface opposite the ground-contacting surface,
an upper body component separate from the lower body component, the upper body component including a lower mating surface opposite the upper surface,
wherein the upper mating surface of the lower body component contacts the lower mating surface of the upper body component.

9. The support of claim 8, wherein the plurality of lift hooks includes:
a first lift hook secured to the lower body component, the first lift hook being configured to support the weight of the lower body component during the transport and positioning thereof, and
a second lift hook secured to the upper body component, the second lift hook being configured to support the weight of the upper body component during the transport and positioning thereof.

10. The support of claim 8, wherein:
the lower body component includes a column extending upwardly from the upper mating surface, the column having a mounting surface formed at a distal end thereof, the mounting surface being configured to receive the base of the tower, and
the upper body component includes an opening extending from the lower mating surface to the upper surface, the opening being sized to receive the column.

11. The support of claim 10, wherein the mounting surface of the column is positioned above the upper surface.

12. The support of claim 10, wherein:
the lower body component includes a sidewall extending from the ground-contacting surface to the upper mating surface, and
a passageway extends from an opening formed in the mounting surface of the column to an opening formed in the sidewall, the passageway being sized to receive electrical and grounding cables extending from the tower when the tower and its corresponding turbine are positioned on the pedestal.

13. The support of claim 8, further comprising a plurality of connecting plates,
wherein each of the connecting plates is secured to the upper body component and the lower body component.

14. A method of deploying a mobile wind power station comprising the steps of:
positioning a pedestal formed from precast concrete on the ground, and
installing a tower and a wind turbine on the pedestal.

15. The method of claim 14, further comprising the step of leveling the ground with crushed rock prior to performing the positioning step.

16. The method of claim 14, wherein the positioning step further includes using a plurality of lift hooks configured to support the weight of the pedestal to position the pedestal on the ground.

17. The method of claim 14, wherein the positioning step further includes:
positioning a first body component,
positioning a second body component, and
coupling the first body component to the second body component to form the pedestal.

18. The method of claim 14, further comprising:
placing approximately two feet below the ground surface at least one electrical grounding device, the electrical grounding device extending horizontally,
passing a grounding cable through a passageway extending from an upper surface of the pedestal to a sidewall of the pedestal, and
connecting the wind turbine to the at least one electrical grounding device.

19. A mobile wind power station comprising:
a wind turbine including a nacelle and a set of rotor blades, the set of rotor blades being operable to rotate on a shaft extending from the nacelle,
a tower extending from a base to an upper end, the upper end of the tower being coupled to the nacelle,
a support coupled to the base of the tower, the support including a mobile, surface-mounted pedestal, the pedestal having a plurality of lift hooks configured to support the weight of the pedestal during the transport and positioning thereof, and
an electrical grounding device coupled to the wind turbine.

20. The mobile wind power station of claim 19, wherein the pedestal is formed from at least two separate body components, each body component being formed from precast concrete.

21. A support for a mobile wind power station, comprising:
a mobile, surface-mounted pedestal including an upper surface opposite a ground-contacting surface, and
a plurality of bolts extending upwardly from the upper surface of the pedestal, each of the bolts being configured to be received in a corresponding opening formed in a base of a wind turbine tower.

22. The support of claim 21, wherein the pedestal is formed from precast concrete.
